(19) United States
(12) Patent Application Publication
(10) Pub. No.: US 2009/0250116 A1
(43) Pub. Date: Oct. 8, 2009

(54) FLOW RATE CONTROLLING APPARATUS

(76) Inventors: Sa-Mun Hong, Gyeonggi-do (KR); Bo-Hyeok Chung, Gyeonggi-do (KR); Chan-Kyoung Park, Gyeonggi-do (KR); Choul-Su An, Gyeonggi-do (KR); Beom-Oui Lee, Gyeonggi-do (KR); Yun-Seok Oh, Gyeonggi-do (KR); Sang-Yeoul Hwang, Gyeonggi-do (KR); Hyun-Chan Cho, Gyeonggi-do (KR)

Correspondence Address: HARNESS, DICKEY & PIERCE, P.L.C., P.O. BOX 828, BLOOMFIELD HILLS, MI, 48303, US

(21) Appl. No.: 12/373,280

(22) PCT Filed: Oct. 2, 2006
(86) PCT No.: PCT/KR06/03959

§ 371 Date: Jan. 9, 2009

(30) Foreign Application Priority Data
Jul. 10, 2006 (KR) 10-2006-006-4366

(51) Int. Cl. G01F 1/34; G01F 1/50; G05D 7/00

(52) U.S. Cl. 137/12; 73/861.42

(57) ABSTRACT

An apparatus for controlling a flow rate of fluid passing through a duct (10) includes a wedge (12) to produce a resistance against a flow of the fluid; pressure sensors (20-1, 20-2), to detect an inflow pressure and an outflow pressure at the upstream and the downstream of the duct (10), respectively, a flow rate controller (22) for measuring a flow rate corresponding to a differential pressure between the inflow and the outflow pressures, comparing the measured flow rate with a predetermined flow rate to regulate an opening angle at an outflow side of the duct (10) using a calculated opening angle, wherein the calculated opening angle being corresponded to a deviation of flow rate between the measured flow rate and the predetermined flow rate; and an error detector (28) for detecting an improper increase of the differential pressure to correctly adjust the opening angle regulated by the flow rate controller.

### TECHNICAL FIELD

The present invention relates to a flow rate controlling apparatus to control a flow rate of a fluid by regulating an opening angle depending on a differential pressure, and more particularly, to a flow rate controlling apparatus and method thereof to prevent an abnormal supply of a fluid by monitoring a flow rate of the fluid being subjected to a regulation in a real time.

### BACKGROUND ART

In general, as known in the art, a duct is provided with a flow rate controlling apparatus to regulate in a real-time a flow rate of a fluid supplied therethrough to a manufacturing apparatus according to a manufacturing recipe or the like.

FIG. 1 shows a schematic diagram of a conventional flow rate controlling apparatus.

As shown in FIG. 1, a duct 10 within which a fluid flows is provided with a V-shaped wedge 12 formed in an inner wall thereof to cause a differential pressure across the flow rate controlling apparatus. The wedge acts as an element for producing a differential pressure between an upstream side (a left side of this drawing) from which the fluid is inflown and a downstream side (a right side of this drawing) to which the fluid is outflown by way of obstructing a sectional area of the duct 10, wherein the differential pressure produced thereof is proportional to the flow rate.

In addition, for example, the element for producing the differential pressure includes an orifice, a porous filter, a nozzle, a capillary tube, and the like.

Further, a pair of pressure sensors 20-1 and 20-2 is located at the upstream and the downstream sides of the duct 10 while maintaining a certain distance from the wedge 12 to detect pressures induced by the wedge 12 at the upstream and the downstream sides of the duct 10, respectively. Alternatively, a single differential pressure sensor may be employed instead of a couple of pressure sensors 20-1 and 20-2. In this regard, the single differential pressure sensor is provided on a branched duct communicated to the upstream and the downstream sides at a certain position of the duct 10, so that the sensor it directly measures the differential pressure between the pressures measured at both the upstream and the downstream sides of the duct 10.

Further, a flow rate controller 22 is electrically connected to the pressure sensors 20-1 and 20-2. The flow rate controller 22 receives an inflow pressure P1 and an outflow pressure transmitted from the pressure sensors 20-1 and 20-2, respectively, to produce a differential pressure ΔP, and obtains a flow rate of a fluid currently passing through the duct 10 using the differential pressure ΔP.

Moreover, a valve 26 is provided at a location closer to the downstream side of the duct 10 than the pressure sensor 20-2 of the outflow side, which is adapted to control the flow rate of a fluid supplied through the duct 10 by regulating a sectional area of a flow path (i.e., an opening angle). The valve 26 is coupled to a driving motor 24 which provides an operational force to the valve 26. Unlike the driving motor 24, a solenoid, an actuator and the like may be used to control the valve 26. These valve elements are subject to a control of the flow rate controller 22.

The operation of the flow rate controlling apparatus will be explained with reference to FIG. 2.

A fluid flows into the duct 10 from the upstream (the inflow) side to the downstream (the outflow) side with a certain pressure. The fluid becomes subject to a resistance to flow while passing through the wedge 12, which results in a change of pressures between the inflow and the outflow sides. More specifically, when the fluid passes the wedge 12 which suddenly narrows in on a sectional area of the duct 10, the pressure applied on the fluid gets boosted to induce a differential pressure between the inflow and the out flow sides.

Accordingly, pressures values P1 and P2 at the inflow and the outflow sides, respectively, are measured by the pressure sensors 20-1 and 20-2, respectively, and then the values are provided to the flow rate controller 22. Thereafter, from the flow rate controller 22, a differential pressure value ΔP is produced using the inflow and the outflow pressure values P1 and P2, the differential pressure value ΔP is corresponding to a difference between the pressures P1 and P2. Further, a flow rate of a fluid currently passing through the duct 10 is measured using the differential pressure ΔP based on Formulas of the Bernoulli's theorem and Conservation of mass.

Then, the flow rate controller 22 compares the measured flow rate with a predetermined reference flow rate to obtain a deviation of a flow rate corresponding to the difference therebetween. Next, a opening angle is evaluated as to make the deviation of a flow rate zero (‘0’). A control signal corresponding to the calculated opening angle is then transmitted to the driving motor 24 to control the valve 26 to be open or closed. Accordingly, an opening ratio of a flow path at an end portion of the duct is changed, thereby substantially regulating the flow rate to a target flow rate.

In addition to the above, joint parts in a shape of a flange may be formed at both of the end portions of the duct 10 to couple with the other ducts thereof.

However, the flow rate controlling apparatus as set forth above has following drawbacks.

Foreign particulars contained in the fluid could get adhered to within the wedge 12 causing a partial clogging in the wedge 12. Further, in case of the wedge 12 being deformed due to collisions with substances in the fluid therewithin, a resistance to flow increases even further, resulting in an increase of a differential pressure ΔP of a fluid. Likewise, the flow rate controller 22 mistakenly considers that there has been a substantial increase of the flow rate proportionally to the increased differential pressure ΔP, thereby further closing the flow path with the driving motor 24 and the valve 26 under control thereof.

As shown in FIG. 3, it is observed that an opening angle is remarkably lowered by the flow rate controller 22 compared with an opening angle at a normal operation.

As above, when a partial clogging occurs at the wedge 12, an amount of the fluid passing through thereof gets decreased. However, because the flow rate controlling apparatus erroneously considers this as an increase of the flow rate in light of the differential pressure ΔP, the flow rate controller 12 controls the flow path to be further closed at the rear end portion of the duct, which in turn, causes an insufficient supply of the fluid in a manufacturing system.

For example, a CMP (Chemical-Mechanical Polisher), one of semiconductor equipments, uses slurry with polishing particulars therein as a polishing agent, the slurry being supplied through a fluid supplying system thereto. However, the particulars in the slurry passing through the fluid supplying system inevitably causes a partial clogging, such that the slurry is not sufficiently supplied to the CMP, which results in an inferior manufacturing for many wafers manufactured. Therefore, critical loss cannot be avoided thereby.

Accordingly, there is a strong need to suggest a novel flow rate controlling apparatus to correctly control the opening angle regardless of partial cloggings and the like.

### DISCLOSURE OF INVENTION

### Technical Problem

An object of the present invention is, therefore, to provide a flow rate controlling apparatus capable of blocking an abnormal supply of a fluid in advance by way of monitoring in real-time an error occurred at the time of controlling the opening angle.

### Technical Solution

In accordance with an aspect of the present invention, there is provided an apparatus for controlling a flow rate of a fluid passing through a duct, which includes: means for producing a resistance against a flow of the fluid; means, located at an upstream and a downstream side of the duct, for detecting an inflow pressure P1 and an outflow pressure P2 at the upstream and the downstream of the duct, respectively; a flow rate controller for measuring a flow rate corresponding to a differential pressure ΔP between the inflow and the outflow pressures P1 and P2, comparing the measured flow rate with a predetermined flow rate to regulate an opening angle at an outflow side of the duct using a calculated opening angle, wherein the calculated opening angle being corresponded to a deviation of flow rate between the measured flow rate and the predetermined flow rate; and an error detector for detecting an improper increase of the differential pressure to correctly adjust the opening angle regulated by the flow rate controller.

In accordance with another aspect of the present invention, there is provided a method of controlling a flow rate of a fluid passing through a duct, the method including the steps of: producing a differential pressure between an inflow pressure and an outflow pressure in the duct detected respectively by pressure sensors; measuring a flow rate corresponding to the differential pressure to produce a measured flow rate; producing a fluctuation of a flow rate between the measured flow rate and a predetermined flow rate; calculating an opening angle corresponding to the fluctuation of a flow rate to control a valve of the duct with a calculated opening angle; determining whether the difference between the calculated opening angle and a normal opening angle is within a predetermined range, wherein the normal opening angle being corresponded to the predetermined flow; and adjusting the opening angle regulated by the flow rate controller if the difference between the normal opening angle and the calculated opening angle is out of the predetermined range.

### Advantageous Effects

According to the present invention, it is possible to prevent an opening angle from being misadjusted in a flow rate controller due to a clogging or the like in a wedge, and therefore, to prevent a badness of goods to be manufactured in a manufacturing apparatus, thereby improving a manufacturing yield.

### BRIEF DESCRIPTION OF THE DRAWINGS

The above and other objects and features of the present invention will become apparent from the following description of preferred embodiments given in conjunction with the accompanying drawings, in which:

FIG. 1 shows a schematic diagram of a conventional flow rate controlling apparatus;

FIG. 2 illustrates a block diagram of a conventional flow rate controlling apparatus shown in FIG. 1;

FIG. 3 describes a graph illustrating a problem of a partial clogging at a wedge side in a conventional flow rate controlling apparatus;

FIG. 4 depicts a schematic diagram of a flow rate controlling apparatus in accordance with the present invention; and

FIG. 5 illustrates a block diagram of a flow rate controlling apparatus shown in FIG. 4.

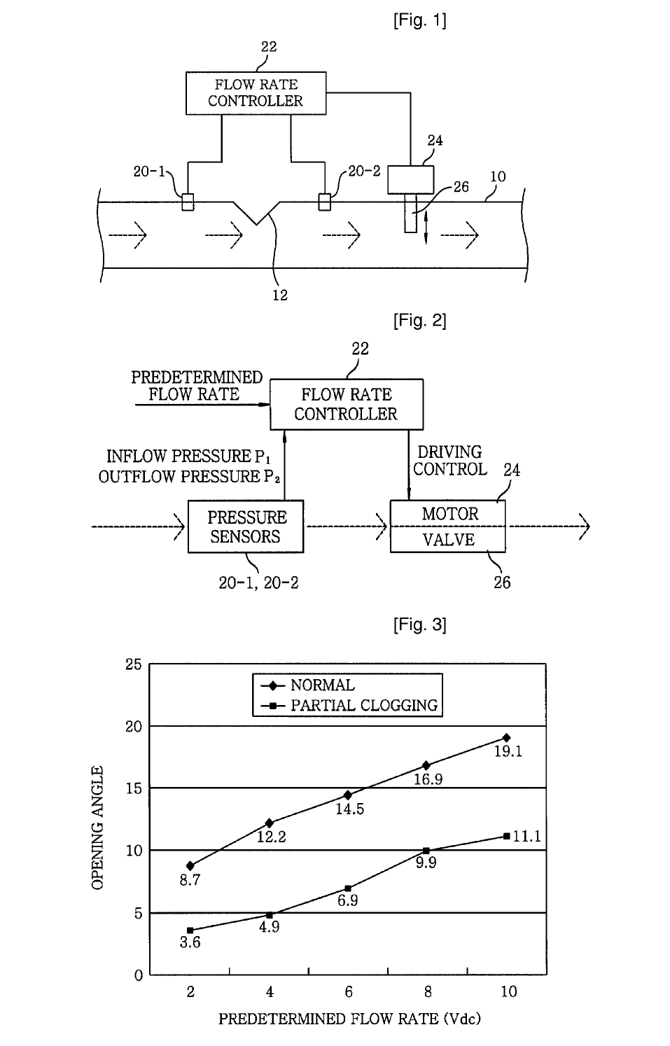

### BEST MODE FOR CARRYING OUT THE INVENTION

Hereinafter, a preferred embodiment of the present invention will be described in detail with reference to the accompanying drawings, wherein like numerical numbers refer to an identical member through the drawings.

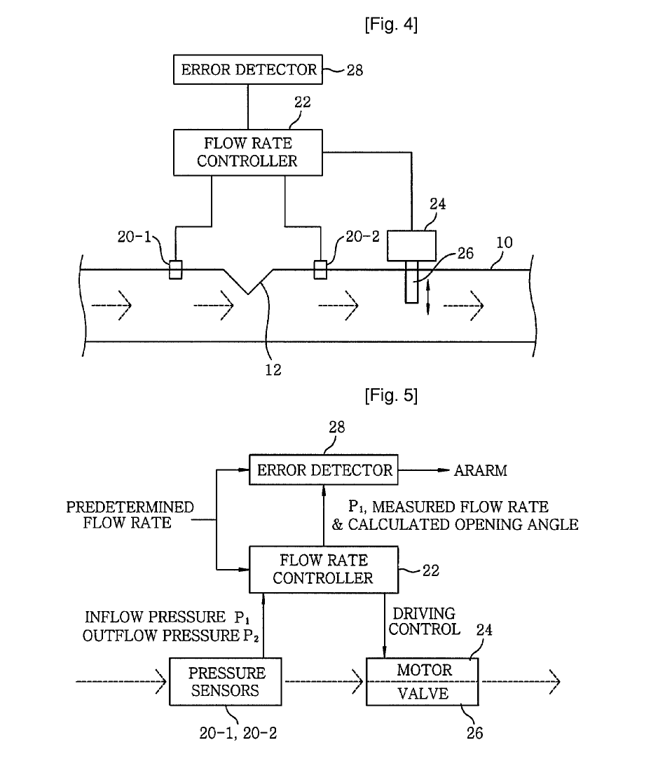

Referring to FIG. 4, there is shown a schematic view of a flow rate controlling apparatus in accordance with the present invention.

As shown in FIG. 4, the flow rate controlling apparatus includes a wedge 12; a pair of pressure sensors 20-1 and 20-2 located at an upstream and a downstream side of a duct 10, respectively, apart from the wedge 12 to detect pressures at the upstream and the downstream sides of the duct 10, respectively; a flow rate controller 22 to measure a deviation of a flow rate and to control of the operation of a driving motor 24 in a manner that the measured deviation of the flow rate becomes zero, to thereby regulate an opening angle of a flow path by allowing a valve 26 to be open or closed under a control of the driving motor 24.

In the flow rate controlling apparatus, there may be a situation that foreign particulars contained in the fluid gets clogged into the wedge 12 causing a partial clogging and collides with the wedge 12 to deform the wedge 12, to thereby closely block the flow path. In these cases, a resistance to flow is further increased, which entails an increase of a differential pressure ΔP of a fluid. Therefore, the flow rate controller 22 mistakenly determines that there has been a substantial increase of the fluid rate proportional to the increased differential pressure ΔP, so that it controls the valve 26 to be close. As a result, the fluid does not get provided smoothly to a manufacturing system which uses the fluid.

In order to overcome the above problem, the present invention further includes a separate error detector 28 connected to the flow rate controller 28. The error detector 28 monitors continuously in real time to detect whether the flow rate controller 22 performs an erroneous control of an opening angle and to inform the situation to an operator or the like with an alarm so that a serious problem can be prevented from occurring.

To this end, the error detector 28 acquires a predetermined flow rate (or a reference flow rate), which may be provided from a user or a system of a manufacturing procedure, and an inflow pressure P1, a measured flow rate and a calculated opening angle that are provided from the flow rate controller 22. Alternatively, the predetermined flow rate may be directly acquired from the flow rate controller 22 as being obtained by the flow rate controller 22.

The measured flow rate acquired from the flow rate controller 22 refers to a flow rate of a fluid derived from the differential pressure by the flow rate controller 22.

Further, the calculated opening angle acquired from the flow rate controller 22 indicates a control signal value to be used for controlling the operation of the driving motor 24 so as for the flow rate controller 22 to offset the deviation of the flow rate representing the difference between the measured flow rate and the predetermined flow rate.

Accordingly, the error detector 28 produces a normal opening angle based on a set of the predetermined flow rate, the inflow pressure P1 and the measured flow rate using a certain equation. Then the error detector 28 compares the normal opening angle with the calculated opening angle to determine whether the difference therebetween is within a designated range. If it is determined that the difference is out of the range, it is regarded that the calculated opening angle is in error. In this regard, the designated range may be differently settled depending on a pressure. For example, if the pressure is in a stable condition, the designated range is settled in narrow, for example approximately 10%; and if the pressure is in an unstable or lower condition, the designated range will be increased inversely.

On the other hand, an alarm sound may be generated to inform of the error, or an electrical alarm signal may be sent to associated equipments in order to warn of the error.

The normal opening angle is calculated by the following Equation:

‘Normal opening angle’=K+S+B

where K represents a coefficient of opening angle pursuant to the range of a predetermined flow rate;

S is a fluctuation of a measured flow rate/a fluctuation of a predetermined flow rate; and

B is a compensation value to a fluctuation of the inflow pressure value P1.

In this regard, the compensation value is used to reversely compensate a variation of an opening angle pursuant to a pressure fluctuation; and has a separate value for each interval.

According to the above Equation, the coefficient of the opening angle K of the predetermined flow rate is compensated with a fluctuation ratio S of the flow rate and a compensation B of the pressure fluctuation. Therefore, it is possible to get a normal opening angle in real time.

Alternatively, it is possible to design that the error detector 28 has a database memory into which “a normal opening angle to a predetermined flow rate” corresponding to “a normal status” as shown in a graph of FIG. 3 is stored. In this case, the error detector 28 reads a normal opening angle to a predetermined flow rate from the database memory and compares the normal opening angle with a calculated opening angle provided from the flow rate controller 22. If the normal opening angle and the calculated opening angle are not accord with each other within a predetermined range, then an alarm is generated to warn of such error.

As described above, by providing to the exterior an alarm or an alarm signal with the error detector, a subsequent operation by an operator or associated devices may performed to block the fluid that is erroneously applied to a manufacturing apparatus. Accordingly, it is possible to prevent an inferior of goods, e.g., wafers, manufactured by such a manufacturing apparatus employing a fluid.

While the invention has been shown and described with respect to the preferred embodiments, it will be understood by those skilled in the art that various changes and modifications may be made without departing from the spirit and scope of the invention as defined in the following claims.

1. An apparatus for controlling a flow rate of a fluid passing through a duct, which comprises:
means for producing a resistance against a flow of the fluid;
means, located at an upstream and a downstream side of the duct, for detecting an inflow pressure P1 and an outflow pressure P2 at the upstream and the downstream of the duct, respectively;
a flow rate controller for measuring a flow rate corresponding to a differential pressure ΔP between the inflow and the outflow pressures P1 and P2, comparing the measured flow rate with a predetermined flow rate to regulate an opening angle at an outflow side of the duct using a calculated opening angle, wherein the calculated opening angle being corresponded to a deviation of flow rate between the measured flow rate and the predetermined flow rate; and
an error detector for detecting an improper increase of the differential pressure to correctly adjust the opening angle regulated by the flow rate controller.

2. The apparatus of claim 1, wherein the error detector includes:
means for producing a normal opening angle to the predetermined flow rate;
means for comparing the normal opening angle with the calculated opening angle;
means for determining whether the difference between the normal opening angle and the calculated opening angle is within a predetermined range;
means for compensating the opening angle regulated by the flow rate controller to adjust the opening angle if the difference between the normal opening angle and the calculated opening angle is out of the predetermined range.

3. The apparatus of claim 1, wherein the error detector obtains the inflow pressure and the measured flow rate from the flow rate controller employed to produce the normal opening angle.

4. The apparatus of claim 1, wherein the normal opening angle is calculated as follows:
Normal opening angle=K+S+B,
where K represents a coefficient of an opening angle pursuant to the range of a predetermined flow rate;
S is a fluctuation of a measured flow rate/a fluctuation of a predetermined flow rate; and
B is compensation to a fluctuation of the inflow pressure.

5. A method of controlling a flow rate of a fluid passing through a duct, the method comprising the steps of:
producing a differential pressure between an inflow pressure and an outflow pressure in the duct detected respectively by pressure sensors;
measuring a flow rate corresponding to the differential pressure to produce a measured flow rate;
producing a fluctuation of a flow rate between the measured flow rate and a predetermined flow rate;
calculating an opening angle corresponding to the fluctuation of a flow rate to control a valve of the duct with a calculated opening angle;
determining whether the difference between the calculated opening angle and a normal opening angle is within a predetermined range, wherein the normal opening angle being corresponded to the predetermined flow; and
adjusting the opening angle regulated by the flow rate controller if the difference between the normal opening angle and the calculated opening angle is out of the predetermined range.

6. The method of claim 5, wherein the normal opening angle is represented as follows:
Normal opening angle=K+S+B,
where K represents a coefficient of an opening angle pursuant to the range of a predetermined flow rate;
S is a fluctuation of a measured flow rate/a fluctuation of a predetermined flow rate; and
B is compensation to a fluctuation of the inflow pressure.
